(19) United States
(12) Patent Application Publication
(10) Pub. No.: US 2026/0039319 A1
(43) Pub. Date: Feb. 5, 2026

(54) CONFIGURABLE GENERAL-PURPOSE RF/ANALOG PROCESSING CIRCUIT

(71) Applicant: Florida State University Research Foundation, Inc., Tallahassee, FL (US)

(72) Inventor: Bayaner Arigong, Tallahassee, FL (US)

(21) Appl. No.: 19/288,607

(22) Filed: Aug. 1, 2025

Related U.S. Application Data
(60) Provisional application No. 63/678,303, filed on Aug. 1, 2024.

(51) Int. Cl. H04B 1/04

(52) U.S. Cl. CPC H04B 1/04; H04B 2001/0416

(57) ABSTRACT

Radio frequency (RF)/analog signal processing circuits are provided. An RF/analog signal processing circuit can be configurable (i.e., able to be configured for a specific task or outcome) and/or general-purpose. The RF/analog signal processing circuits can realize multiple operations, including integration, differentiation, spectrum sniffing, matrix multiplication, and/or beamforming directly at RF waveform domain in a single chip. The circuits can support a frequency range of, for example, direct current (DC) to 50 gigahertz (GHz) or more.

### CROSS-REFERENCE TO RELATED APPLICATION

This application claims the benefit of U.S. Provisional Application Ser. No. 63/678,303, filed Aug. 1, 2024, the disclosure of which is hereby incorporated by reference in its entirety, including all figures, tables, and drawings.

### BACKGROUND

State-of-the-art analog and radio frequency (RF) processing performs a single operation at a time with a fixed operating frequency and a narrow band.

### BRIEF SUMMARY

Existing analog and radio frequency (RF) processing as mentioned in the Background is not scalable to support complex mathematical operations and wideband signal processing. In order to address this shortcoming, embodiments of the subject invention provide novel and advantageous radio frequency (RF)/analog signal processing circuits, as well as methods of fabricating and methods of using the same. An RF/analog signal processing circuit can be configurable (i.e., able to be configured for a specific task or outcome) and/or general-purpose. The RF/analog signal processing circuits can realize multiple operations, including integration, differentiation, spectrum sniffing, matrix multiplication, and/or beamforming directly at RF waveform domain in a single chip. The circuits can support a frequency range of, for example, direct current (DC) to 50 gigahertz (GHz) or more. As with digital field-programmable gate arrays (FPGAs), the RF/analog signal processing circuits of embodiments can be programed in real-time to perform a single operation, simultaneous multiple operations, and/or time-sequenced complex operations.

In an embodiment, an RF/analog signal processing circuit can comprise: an input; an output; and a plurality of variable gain amplifiers (VGAs) electrically connected to each other, the input, and the output. Each VGA of the plurality of VGAs can have: a respective first transmission line based fixed time delay on an input side of the respective VGA; and a respective second transmission line based fixed time delay on an output side of the respective VGA. For each VGA of the plurality of VGAs, the first transmission line based fixed time delay can be equal to the second transmission line based fixed time delay of the respective VGA. The RF/analog signal processing circuit can operate according to a discrete transfer function (e.g., the discrete transfer function defined in Equation (1) herein). The RF/analog signal processing circuit can be configured to be programed in real-time to perform a single operation, simultaneous multiple operations, and/or time-sequenced complex operations. The RF/analog signal processing circuit can be configured to perform integration, differentiation, spectrum sniffing, matrix multiplication, and/or beamforming directly at RF waveform domain. The RF/analog signal processing circuit can be configured to operate at direct current (DC) and/or a frequency in a range of, for example, from 0.001 Hertz (Hz) to 1000 gigahertz (GHz) (or any subrange or value contained therein, such as from 1 Hz to 100 GHz). The RF/analog signal processing circuit can be, for example, an RF temporal integrator (which can have a frequency response as defined in Equation (3) or Equation (4)) or an RF temporal differentiator (with a transfer function as defined in Equation (7)). The RF/analog signal processing circuit can be contained on a single chip.

In another embodiment, an RF/analog signal processing unit can comprise a plurality of RF/analog signal processing circuits as described herein (e.g., including any of the features discussed in the previous paragraph). At least a portion of the RF/analog signal processing circuits can be connected in series, and/or at least a portion of the RF/analog signal processing circuits can be connected in parallel. In some embodiments, all of the RF/analog signal processing circuits present can be connected in series, or all of the RF/analog signal processing circuits present can be connected in parallel. The RF/analog signal processing unit can be contained on a single chip.

In another embodiment, a method for performing RF/analog processing comprise: providing an RF/analog signal processing circuit and/or an RF/analog signal processing unit as described herein (e.g., having any of the features discussed in the previous two paragraphs); and operating the RF/analog signal processing circuit and/or the RF/analog signal processing unit to perform the RF/analog processing. The RF/analog signal processing circuit and/or RF/analog signal processing unit can be contained on a single chip. The operating step can comprise performing a single operation, simultaneous multiple operations, and/or time-sequenced complex operations. The operating step can comprise, for example, integration, differentiation, spectrum sniffing, matrix multiplication, and/or beamforming directly at RF waveform domain.

### BRIEF DESCRIPTION OF DRAWINGS

FIG. 1 shows a schematic diagram of a radio frequency (RF)/analog signal processing circuit, according to an embodiment of the subject invention.

FIG. 2 shows a schematic diagram of temporal integration, according to an embodiment of the subject invention. The upper-left portion of FIG. 2 shows a plot of RF input versus time (in seconds (s)); the lower-left portion of FIG. 2 shows a plot of impulse versus time (in s); and the right portion of FIG. 2 shows a plot of integration versus time (in s).

FIG. 3A shows a delayed and truncated Hilbert transform, with impulse response in time domain.

FIG. 3B shows a delayed and truncated Hilbert transform, with frequency response including both magnitude and phase.

### DETAILED DESCRIPTION

Embodiments of the subject invention provide novel and advantageous radio frequency (RF)/analog signal processing circuits, as well as methods of fabricating and methods of using the same. An RF/analog signal processing circuit can be configurable (i.e., able to be configured for a specific task or outcome) and/or general-purpose. The RF/analog signal processing circuits can realize multiple operations, including integration, differentiation, spectrum sniffing, matrix multiplication, and/or beamforming directly at RF waveform domain in a single chip. The circuits can support a frequency range of, for example, direct current (DC) to 50 gigahertz (GHz) or more. As with digital field-programmable gate arrays (FPGAs), the RF/analog signal processing circuits of embodiments can be programed in real-time to perform a single operation, simultaneous multiple operations, and/or time-sequenced complex operations.

Processing a signal directly at analog and RF waveform level can boost up the computation speed of existing and future computing systems, which can be applied in wideband wireless communication, artificial intelligence (AI), brain-machine interaction, quantum computers, and other technologies. While existing RF/analog processing performs a single operation at a time with a fixed operating frequency and a narrow band, which are not scalable to support complex mathematical operation and wideband signal processing, embodiments of the subject invention can be programed in real-time to perform a single operation, simultaneous multiple operations, and/or time-sequenced complex operations over a wide frequency range.

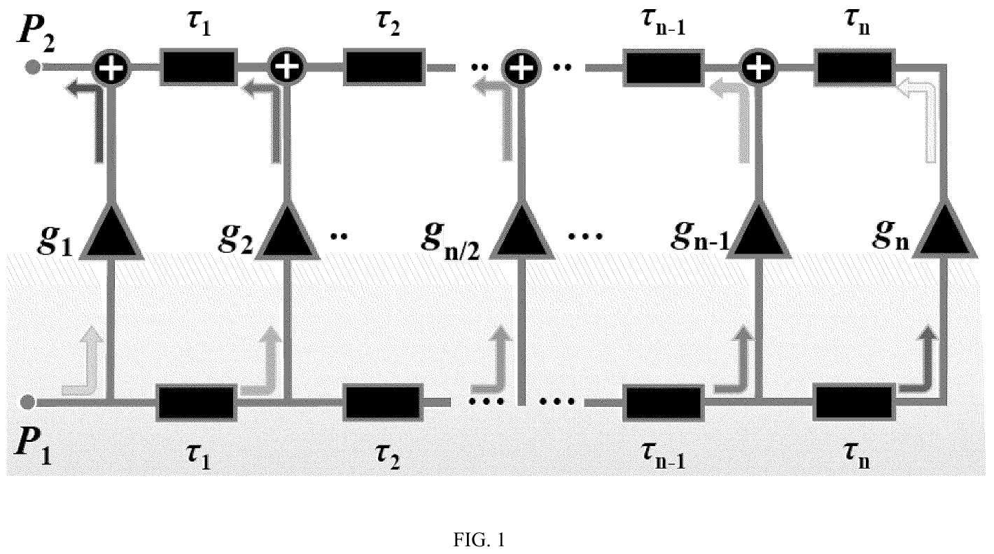

Unlike any existing RF/analog processor, embodiments of the subject invention can include a novel circuit topology for a basic RF/analog processing unit, which can include fixed transmission line based time delay units and multiple variable gain amplifier (VGA) blocks. FIG. 1 shows a schematic diagram of an RF/analog signal processing circuit, according to an embodiment of the subject invention. Referring to FIG. 1, the input RF waveform (from P₁) can be delayed with a fixed time to the input of VGAs, and the amplified waveform from each VGA can be combined (at P₂) with the same time delay at their respective inputs. This basic processing unit can behave as a discrete transfer function, where the gain coefficient distribution (VGAs gain) and time delay (transmission line fixed time delay) can determine the different mathematical operation and max operating frequency band. The transfer function of the RF signal processing circuit can be derived as shown in Equation (1):

$$H ( ω ) = {{\sum }^{N}}_{n = 1} {g}_{n} {e}^{- j ω ( n - 1 ) \cdot {τ}_{n}} \qquad ( 1 )$$

where H(ω) is the transfer function, ω is the angular frequency, n is the number of VGAs, gₙ is the gain coefficient of the n^{th} VGA, and τₙ is the time delay of the n^{th} VGA. By configuring gₙ and τₙ, more complex operations or signal processing can be developed (e.g., spectrum sniffing, single side band modulation, integration, differentiation, beamforming, and/or matrix multiplication). This can be done by, for example, connecting multiple basic units (each basic unit being as shown in FIG. 1) in parallel or in series. Two examples of RF signal processing will be discussed in detail below, an RF temporal integrator, and an RF temporal differentiator. These are presented for exemplary purposes only and should not be construed as limiting.

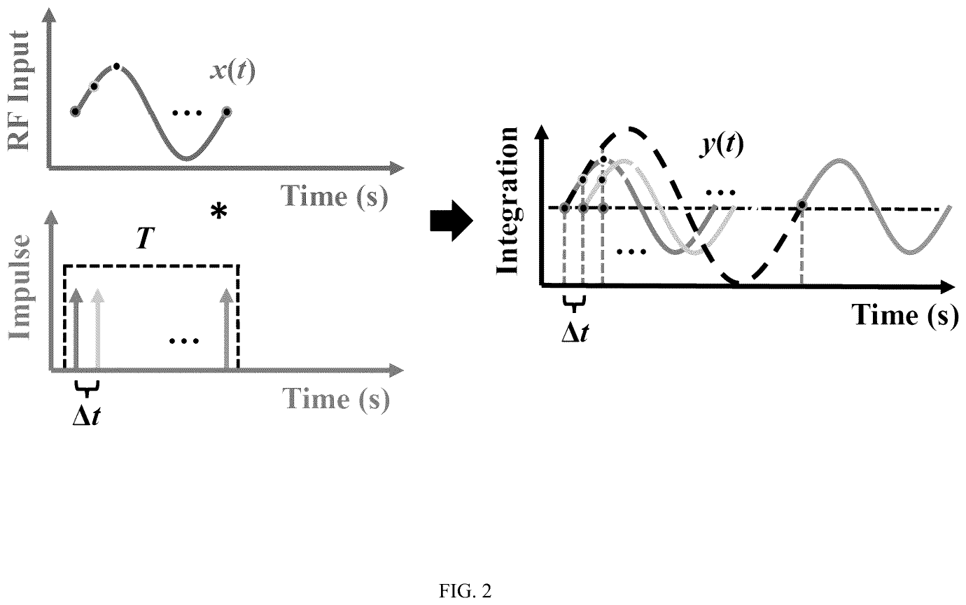

With respect to an RF temporal integrator, the operation of the temporal integration can be achieved via a discrete time-spectrum operation between the RF input signal x(t) and its delayed version with step Δt. The output signal y(t) can be described as shown in Equation (2):

$$y ( t ) = {{\sum }^{N}}_{n = 1} x ( t + n \cdot Δ t ) \qquad ( 2 )$$

where N is the total number of delay sections and t is the time. After the replicas of x(t) are delayed progressively and summed together, the integration of x(t) can be achieved with a total integration time window T=N×Δt, as shown in FIG. 2. The frequency-domain transmission response of an ideal non-discrete integrator is linear to 1/(jω), such that the frequency response of the discrete integrator can be described as shown in Equation (3):

$$H ( ω ) = {{\sum }^{N}}_{n = 1} {e}^{- j ω n \cdot {τ}_{n}} \qquad ( 3 )$$

where ω is the angular frequency. In order to achieve the identical discrete signal, the values of both delay increments τₙ and amplitude weighting gₙ should be kept the same, respectively. Therefore, Equation (3) can be modified as Equation (4):

$$H ( ω ) = {{\sum }^{N}}_{n = 0} {g}_{n} \cdot {e}^{- j ω n \cdot {τ}_{n}} \qquad ( 4 )$$

With respect to an RF temporal differentiator, a temporal RF fractional differentiator can be considered as a linear time-invariant (LTI) system with a transfer function given by Equation (5):

$$H ( ω ) = [ j ( ω - {ω}_{0} ) ] = \{ \begin{matrix}{e}^{j ( π / 2 )} \cdot \vert ω - {ω}_{0} \vert , & ω > {ω}_{0} \\ {e}^{- j ( π / 2 )} \cdot \vert ω - {ω}_{0} \vert , & ω < {ω}_{0}\end{matrix} \qquad ( 5 )$$

The temporal differentiator has a magnitude response of |ω−ω0|, and a phase jump of π at null ω₀. As another fundamental function in signal processing, Hilbert transform (HT) provides an instant phase rotation of π while achieving constant magnitude response on an RF signal, and the theoretical transfer function can be expressed as Equation (6):

$${H}_{h ilbert} ( ω ) = \{ \begin{matrix}{e}^{j \frac{π}{2}} , & if {ω}_{0} > 0 \\ {e}^{- j \frac{π}{2}} , & if {ω}_{0} < 0\end{matrix} \qquad ( 6 )$$

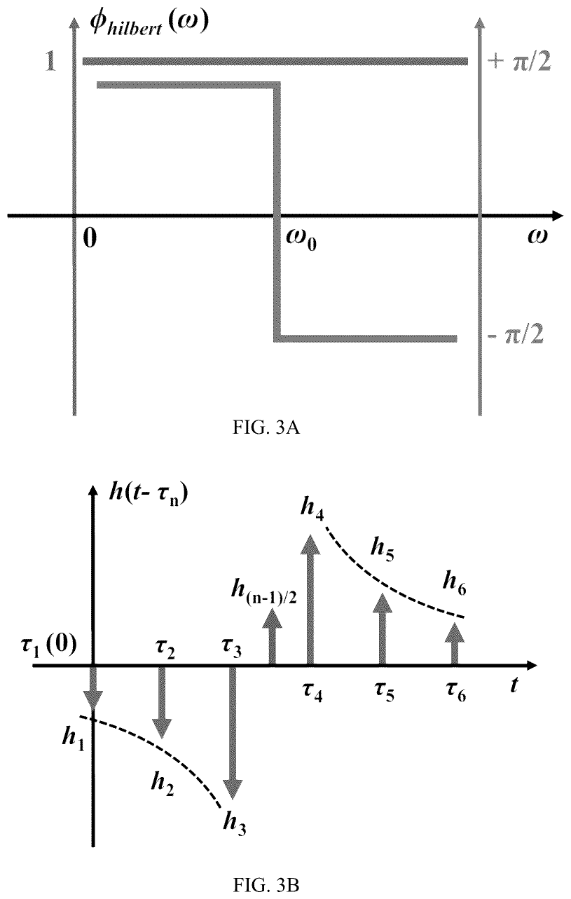

Its temporal expression in time domain can be given as h(t)=1/(γ·t). By comparing Equation (4) and Equation (5), it has been found that the temporal differentiation can be treated as the delayed and truncated version of Hilbert transform, as shown in FIG. 3A.

Similar to the structure of an RF temporal integrator, the transfer function of the RF fractional differentiator can be expressed as Equation (7):

$$H ( ω ) = {{\sum }^{N}}_{n = 0} {h}_{n} \cdot {e}^{- j ω n \cdot {τ}_{n}} \qquad ( 7 )$$

where N is the number of taps, τₙ is the time delay between adjacent taps, and hₙ is the tap coefficient of the n^{th} tap. The values of amplitude coefficients hₙ should be obtained from the discrete impulse response of Hilbert transform h(t−τₙ), as shown in FIG. 3B.

Embodiments of the subject invention provide configurable RF/analog signal processing circuits/units that can significantly save the power consumption of all computing more than 10 times and resolve the issue of bandwidth limitations of existing processing units. With parallel or serial connection of multiple basic RF/analog processing units and configuration of gain distribution of each basic unit, the output response of the circuit topology is independent of frequency band (upper frequency is defined by fixed time delay unit), and the phase difference between each channel of the basic unit is flat across the whole frequency range and tuned by controlling center gain coefficient, which can enable frequency-free or ultra broadband beamforming phased array and other signal processing. The wideband beamforming phased array has wide application in 5G/NextG, radar, sensing, and other wireless networks. The RF signal processing functions have wide applications in AI, quantum computing, and high speed computers, with the ability to boost the computation speed with less energy and resource consumption.

When ranges are used herein, combinations and subcombinations of ranges (e.g., subranges within the disclosed range) and specific embodiments therein are intended to be explicitly included. When the term “about” or “approximately” is used herein, in conjunction with a numerical value, it is understood that the value can be in a range of 95% of the value to 105% of the value, i.e., the value can be +/−5% of the stated value. For example, “about 1 kg” means from 0.95 kg to 1.05 kg.

The methods and processes described herein can be embodied as code and/or data. The software code and data described herein can be stored on one or more machine-readable media (e.g., computer-readable media), which may include any device or medium that can store code and/or data for use by a computer system. When a computer system and/or processor reads and executes the code and/or data stored on a computer-readable medium, the computer system and/or processor performs the methods and processes embodied as data structures and code stored within the computer-readable storage medium.

It should be appreciated by those skilled in the art that computer-readable media include removable and non-removable structures/devices that can be used for storage of information, such as computer-readable instructions, data structures, program modules, and other data used by a computing system/environment. A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); network devices; or other media now known or later developed that are capable of storing computer-readable information/data. Computer-readable media should not be construed or interpreted to include any propagating signals. A computer-readable medium of embodiments of the subject invention can be, for example, a compact disc (CD), digital video disc (DVD), flash memory device, volatile memory, or a hard disk drive (HDD), such as an external HDD or the HDD of a computing device, though embodiments are not limited thereto. A computing device can be, for example, a laptop computer, desktop computer, server, cell phone, or tablet, though embodiments are not limited thereto.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

What is claimed is:

1. A radio frequency (RF)/analog signal processing circuit, comprising:
an input;
an output; and
a plurality of variable gain amplifiers (VGAs) electrically connected to each other, the input, and the output,
wherein each VGA of the plurality of VGAs has a respective first transmission line based fixed time delay on an input side of the respective VGA, and
wherein each VGA of the plurality of VGAs has a respective second transmission line based fixed time delay on an output side of the respective VGA.

2. The RF/analog signal processing circuit according to claim 1, wherein, for each VGA of the plurality of VGAs, the first transmission line based fixed time delay is equal to the second transmission line based fixed time delay of the respective VGA.

3. The RF/analog signal processing circuit according to claim 1, wherein the RF/analog signal processing circuit operates according to a discrete transfer function.

4. The RF/analog signal processing circuit according to claim 3, wherein the discrete transfer function is H(ω) and is defined as follows:
$$H ( ω ) = {{\sum }^{N}}_{n = 1} {g}_{n} \cdot {e}^{- j ω ( n - 1 ) \cdot {τ}_{n}}$$
where ω is an angular frequency, n is a number of VGAs of the plurality of VGAs, gₙ is a gain coefficient of the n^{th} VGA, and τₙ is the first transmission line based fixed time delay of the n^{th} VGA.

5. The RF/analog signal processing circuit according to claim 1, wherein the RF/analog signal processing circuit is configured to be programed in real-time to perform at least one of: a single operation; simultaneous multiple operations; and time-sequenced complex operations.

6. The RF/analog signal processing circuit according to claim 1, wherein the RF/analog signal processing circuit is configured to perform at least one of: integration; differentiation; spectrum sniffing; matrix multiplication; and beamforming directly at RF waveform domain.

7. The RF/analog signal processing circuit according to claim 1, wherein the RF/analog signal processing circuit is configured to operate at direct current (DC) or at a frequency of from 1 Hertz (Hz) to 100 gigahertz (GHz).

8. The RF/analog signal processing circuit according to claim 1, wherein the RF/analog signal processing circuit is an RF temporal integrator.

9. The RF/analog signal processing circuit according to claim 8, wherein a frequency response of the RF temporal integrator is H(ω) and is defined as follows:
$$H ( ω ) = {{\sum }^{N}}_{n = 0} {e}^{- j ω n \cdot {τ}_{n}}$$
where ω is an angular frequency, n is a number of VGAs of the plurality of VGAs, and τₙ is the first transmission line based fixed time delay of the n^{th} VGA.

10. The RF/analog signal processing circuit according to claim 1, wherein the RF/analog signal processing circuit is an RF temporal differentiator.

11. The RF/analog signal processing circuit according to claim 10, wherein a transfer function of the RF temporal differentiator is H(ω) and is defined as follows:
$$H ( ω ) = {{\sum }^{N}}_{n = 0} {h}_{n} \cdot {e}^{- j ω n \cdot {τ}_{n}}$$
where ω is an angular frequency, N is a number of taps, τₙ is a time delay between adjacent taps, and hₙ is a tap coefficient of the n^{th} tap.

12. A method for performing RF/analog processing, the method comprising:
providing an RF/analog signal processing circuit according to claim 1; and
operating the RF/analog signal processing circuit to perform the RF/analog processing.

13. The method according to claim 12, wherein the operating step comprises performing at least one of: a single operation; simultaneous multiple operations; and time-sequenced complex operations.

14. The method according to claim 12, wherein the operating step comprises at least one of: integration; differentiation; spectrum sniffing; matrix multiplication; and beamforming directly at RF waveform domain.

15. An RF/analog signal processing unit, comprising:
a plurality of RF/analog signal processing circuits according to claim 1,
wherein the RF/analog signal processing unit has at least one of the following features:
at least a portion of the RF/analog signal processing circuits are connected in series; and
at least a portion of the RF/analog signal processing circuits are connected in parallel.

16. The RF/analog signal processing unit according to claim 15, wherein: all of the RF/analog signal processing circuits are connected in series; or all of the RF/analog signal processing circuits are connected in parallel.

17. The RF/analog signal processing unit according to claim 15, wherein, within each RF/analog signal processing circuit of the plurality of RF/analog signal processing circuits, for each VGA of the plurality of VGAs, the first transmission line based fixed time delay is equal to the second transmission line based fixed time delay of the respective VGA.

18. A method for performing RF/analog processing, the method comprising:
providing an RF/analog signal processing unit according to claim 15; and
operating the RF/analog signal processing unit to perform the RF/analog processing.

19. The method according to claim 18, wherein the operating step comprises performing at least one of: a single operation; simultaneous multiple operations; and time-sequenced complex operations.

20. The method according to claim 18, wherein the operating step comprises at least one of: integration; differentiation; spectrum sniffing; matrix multiplication; and beamforming directly at RF waveform domain.
